(19) United States
(12) Patent Application Publication
(10) Pub. No.: US 2002/0143896 A1
(43) Pub. Date: Oct. 3, 2002

(54) Efficient downloading of documents from the internet

(76) Inventors: Uwe Hansmann, Altdorf (DE); Lothar Merk, Schoenbuch (DE); Thomas Stober, Boeblingen (DE)

Correspondence Address: James E. Murray, 69 South Gate Drive, Poughkeepsie, NY, 12601, US

(21) Appl. No.: 09/734,224

(22) Filed: Dec. 11, 2000

(30) Foreign Application Priority Data
Dec. 30, 1999 (DE) 19964030.0

(51) Int. Cl. G06F 15/16

(52) U.S. Cl. 709/218

(57) ABSTRACT

The time during which a data link is not being used, it is used to download those pages to which references are made by links. If one of the pages downloaded in anticipation is needed later on (namely when the user does in fact select the link concerned), the page is already in the cache of the local computer and can be displayed at once. The automatic downloading in anticipation can be initiated both by the client and by the server. The automatic downloading takes place during the time when an already established connection exists. In this way any unused capacity the connection has is exploited to the full. This improves the economics or in other words allows fuller use to be made of the chargeable (telephone) connection which has been made to the network service provider. The automatic downloading is adjusted to the user's habits: the downloading of subsequent pages can be influenced directly by setting certain configuring parameters and indirectly by analyzing the user's behavior during use (anticipatory downloading or preloading).

### FIELD OF THE INVENTION

The present invention relates to a system and method for the efficient downloading of information from the network, and in particular to a system and method for making use of the capacity of the network link which is left idle when a selected web page is being viewed.

### BACKGROUND OF THE INVENTION

When one of today's network users uses a browse to show him an HTML document and, after a time, selects a link in the document which takes him to another HTML page, the browse does not begin to download the relevant data from the network until after the link has been selected. If the user has already looked at the page in question previously, and if as a result the page still happens to be in his computer's local cache, then it will be displayed more quickly. If however the page is not in a cache, the data contained in it will be downloaded from the server to the client via the network.

Over the period when the user is viewing a fully downloaded page, the limited transmitting capacity of the user's data link is not being used. Nevertheless, charges are incurred for the connection which has been established.

U.S. Pat. No. 5,896,502 describes a method and system for the controlled transmission of a web page from a web server to a client system. The method is mainly directed to breaking off the downloading of information from the network when the time taken by the transmission is of more than a defined length.

U.S. Pat. No. 5,931,904 describes a method for the speedier display of information from the network by the installation of a local proxy.

U.S. Pat. No. 5,946,697 describes a method for the compressed transmission of HTML pages.

WO 9908429A1 describes a system and method for the speedier downloading of the individual items of information making up an HTML document.

JP 10124413A describes a method for the prioritised downloading of components of the information making up an HTML document. The web author allots priorities reflecting the importance of the individual information objects forming an HTML document.

The object of the present invention is therefore to provide a system and method for the efficient downloading of information from the net where the downloading is adjusted to the user's actual behaviour.

### BRIEF DESCRIPTION OF THE INVENTION

In accordance with the present invention, the link information is expanded to include priority information, all the links featured on a web page are prioritised and, without being selected by the user, are automatically downloaded in the background in line with the prioritisation. This speeds up the downloading of a series of web pages to which there are connections by links. This means a considerable increase in the performance of the function for viewing linked web pages.

The automatic downloading takes place during the time when an already established connection exists. In this way any unused capacity of the connection is exploited to the full. This improves the economics or in other words allows fuller use to be made of the chargeable (telephone) connection which has been made to the network service provider.

The method according to the invention adjusts the automatic downloading to the user's habits: the downloading of subsequent pages can be influenced directly by setting certain configuring parameters and indirectly by analysing the user's behaviour during use (anticipatory downloading or preloading).

The method according to the invention makes it possible for web authors to predetermine the downloading of subsequent pages by assigning priorities. In addition, the user can himself make a selection determining the pages to be downloaded from configuration menus which may be part of a browse or of an add-on program for the relevant browsers.

### BRIEF DESCRIPTION OF THE DRAWINGS

The present invention will now be described by reference to a preferred embodiment and to figures, in which:

FIG. 1 is a flow chart showing the method according to the invention,

FIG. 2 shows the method according to the invention implemented in a client-proxy server architecture on the basis of a user configuration,

FIG. 3 shows a further implementation of the method according to the invention in a client-proxy server architecture on the basis of a proxy server configuration;

FIG. 4 shows a dialogue template for configuring the implementations shown in FIGS. 2 and 3; and

FIG. 5 is a block diagram of a computer system and media that can be used with the present invention.

### DETAILED DESCRIPTION OF THE INVENTION

To put the present invention into practice, the time during which the user is working his way through a page, or in other words the time during which the data link is not being used, is used to download those pages to which references are made by links. If one of the pages downloaded in anticipation is needed later on (namely when the user does in fact select the link concerned), it is already in the cache of the local computer and can be displayed at once.

The following mechanisms can be employed for the automatic anticipatory downloading:

1) Client-initiated automatic downloading:

a) web-author-controlled downloading

b) browser-controlled downloading

c) user-controlled downloading

2) Server/gateway-initiated downloading:

a) web-author-controlled downloading

b) server-operator-controlled downloading

c) statistically controlled downloading.

Web-author-controlled downloading is achieved by establishing an interrelationship between web pages which belong together. The existing tags which define the links between web pages are expanded to include an additional parameter. In the tag used by HTML to make reference to another page, the author of the HTML page can state the priorities the various links are to be given, or in other words how important they are to be considered, and can say which of them are most likely to be pursued. The link with the lowest numbered priority is downloaded first during the “pause”.

Example of an HTML page and its priority levels:

. . . . . .
<a prio=5 href=“/docs/gim/ocfgim.html”><b>General
Information Web Document</b></a>
. . . . . .
<a prio=6 href=“/News/SystemTest/”>OCF System Testing suite
available</a>
. . . . . .
<a prio=2 href=′http://www.ibm.com/pvc=>IBM Pervasive
Computing</a>
. . . . . .

In the present example, the ‘IBM Pervasive Computing’ page would be downloaded first, followed by ‘General Information Web’ and then by ‘OCF Testing suite available’. In this way, authors of web pages can greatly improve the overall impression the sites make in terms of performance and can increase the acceptance of their pages.

In the case of browser-controlled downloading, the browse automatically creates user profiles which observe and analyse the behaviour of users. At the client end, the preferred solution includes in the browse a semantic network which is built up from information on the behaviour of the user by data mining and statistical methods. Then, the moment the user views a page, the browse prioritises the links included in the page on the basis of the information which has been assembled on the behaviour of the user and starts to download the most probable subsequent pages in background. Neuronal networks too may advantageously be used to detect behaviour. In this way the anticipatory downloading can be individually adjusted to the user's habits and can be optimised.

User-controlled downloading means that it is open to the user to determine the behaviour of the browse by using configuring menus and by setting options. The user can employ configuring parameters to specify whether it is complete pages, or alternatively only parts thereof, which are to be downloaded, in accordance with priorities or with probability. Lowest priorities/probabilities required for anticipatory downloading can be defined. Also, the user can define a series of pages which are to be downloaded automatically in the pauses which become available during use. A daily “internet round” can be defined in this way: the pages which have been defined, such as stock exchange bulletins, weather reports and newspaper headlines, will be downloaded continuously making full use of the network connection available and they can then be viewed in peace off-line without being connected to the network service provider.

Server-initiated downloading is preferably used in the area of ISDN or mobile telephony. In this case the gateway acts as an exchange between the terminals and the network. In the area of mobile telephony, the mobile phone communicates with the gateway server by WAP. When the user of the mobile phone wants information from the network, the gateway server makes the call to the desired web page on the network and downloads the page to its server and transmits the desired information from the web page selected to the mobile phone user. At the same time the gateway server performs the method according to the invention to identify and select links from the web page currently being processed and downloads the selected web pages to its cache in anticipation. This reduces the costly connection times between terminal users and the operator of the gateway which would be needed to call up information. The same method can also be employed in the ISDN area when the communication takes place via a gateway. It is also possible for the operator of the gateway server to employ a statistical process for determining the relevant web page by using a data mining program in order to select the web page which is to be downloaded in anticipation. Similarly simple operator configuration settings, e.g. sequential downloading, may also be considered.

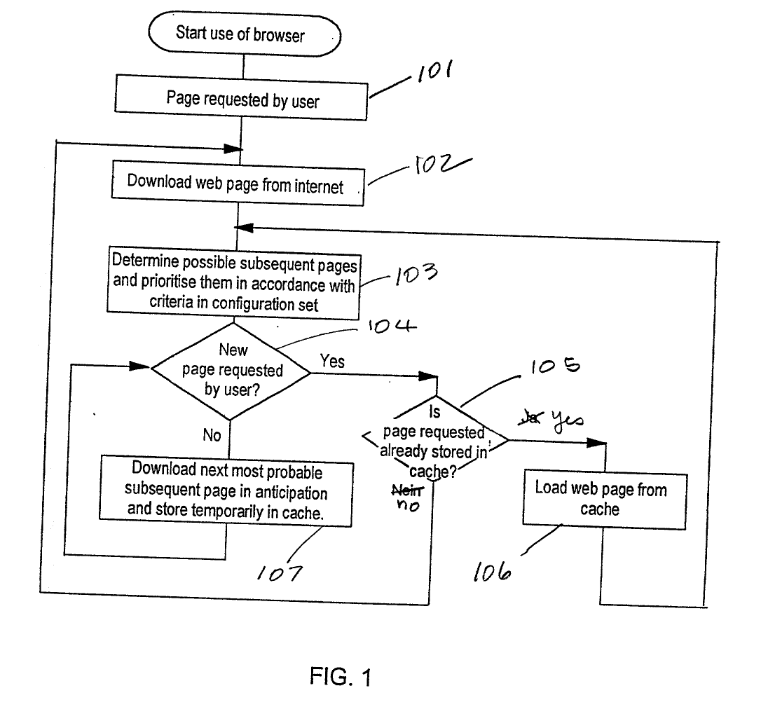

FIG. 1 is a flow chart showing the method according to the invention.

An network URL (universal resource locator) is entered to select a given web page on the network (step 101) and the site is downloaded to the client's volatile or non-volatile cache (step 102). There the web page is checked for all the links it includes (step 103). This check is made by means of an add-on program, e.g. a so-called plug-in, or a browse extension. The job of the add-on program or browse extension is to identify links by reference to predefined settings and download them automatically. There are various methods which can be employed to identify and select the links. The links themselves may contain information, e.g. priority information. The add-on program or browse extension reads the items of priority information in the individual links and downloads the respective web pages from the server to the client in the sequence determined by the order of priorities while the user is still looking at the original web page.

However, for this to be possible it is essential for the web author to have prepared the links by providing them with priority information. Where this has not been done, other methods have to be employed to select the links. These methods may for example be:

Sequential downloading of the links—In this case the links are identified and automatically downloaded sequentially by the add-on program or browse extension.

Sequential downloading of the links in accordance with a user setting—The settings in this case may for example be these: “from centre”, “top-down” or “bottom-up”.

Determination of behaviour-specific parameters and allocation of links in the light of them. This method usually requires the use of a data mining program.

Downloading of the links in accordance with search terms which have been entered and which are freely definable by the user.

The web pages which can be addressed by the links are downloaded automatically to the client by the add-on program or browse extension. Depending on the browse setting the downloading may be to the cache of the RAM (memory cache) or the cache of the hard disk (disk cache).

When a user selects a new link on the web page and enables it (step 104), the add-on program or browse extension checks to see whether the web page allocated to the link is already in store in the client's cache (step 105). If it is, it is downloaded from the cache (step 106) and displayed. The new web page too is checked for any links it may contain by the add-on program or browse extension. If it does contain links, the method according to the invention is started again.

If however the link which the user has selected and enabled is one whose web page is not in store in the client's cache, the web page concerned has to be downloaded from the network in a fresh operation (step 107). The method described above for identifying the links a page has then starts for the new web site.

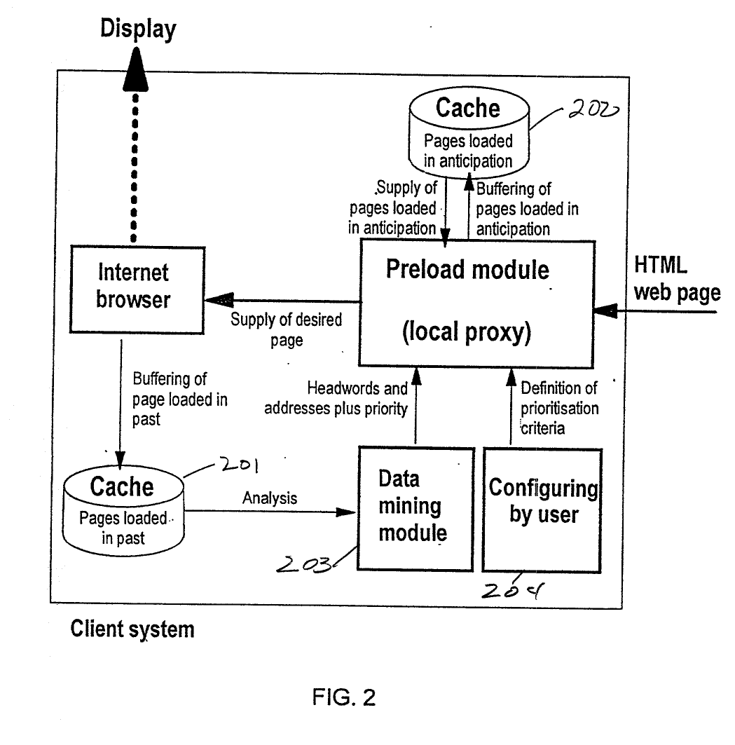

FIG. 2 shows the method according to the invention implemented in a client-proxy server architecture on the basis of a user configuration.

The client-proxy server architecture comprises a client having a browse and a cache, and a proxy server having a cache. The client communicates with the network via the proxy server. What is stored in the client's cache is data representing web pages/links which have been downloaded in the past 201.

Stored in the proxy server's cache are web pages which have been downloaded in anticipation 202. These web pages are selected by means of a data mining program 203 and a user-set configuration 204. The data mining program has access to the data in the client's cache in this case. On the basis of this data and the user-set configuration, certain links are selected from those present on a web page which the client is currently dealing with and their associated web pages are downloaded to the proxy server's cache in accordance with the priorities assigned to them. If the user selects a link, the web page associated with the link is transmitted from the proxy server to the client. This causes the method to be reinitiated, i.e. the data mining program and the user-set configuration select certain links on the web page which is currently in use and automatically download the web pages assigned to these links to the proxy server's cache.

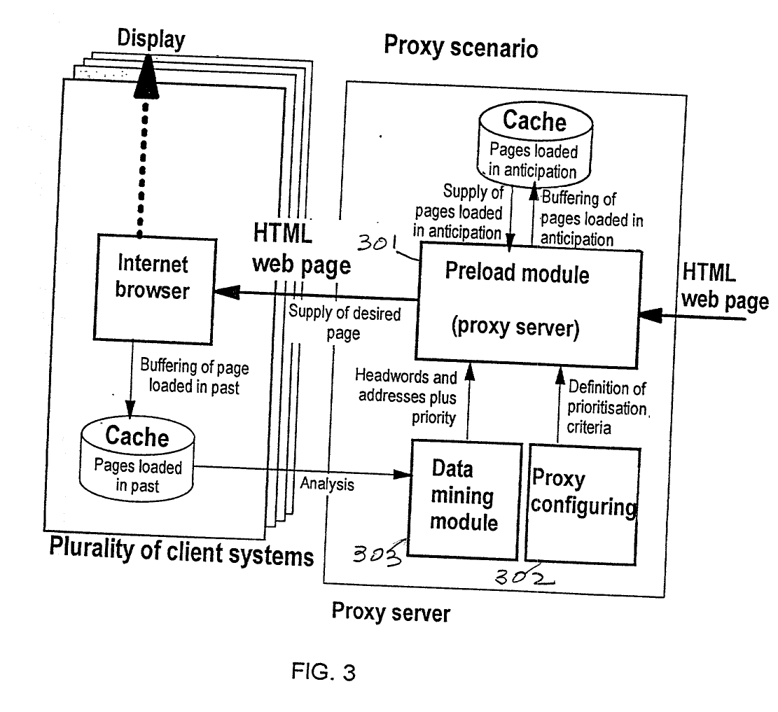

FIG. 3 shows a modified version of the client-proxy server architecture shown in FIG. 2. In this implementation, the web pages to be downloaded are selected by the operator of the proxy server 301. Where the proxy server is being operated by a company, it is the company that creates a proxy configuration 302 on the basis of its operating requirements. An additional data mining module 303 can change the proxy configuration. The data mining module is preferably installed on the proxy server. What the proxy server configuration lays down in this case is a definition of priority criteria. These priority criteria are accepted by a program (preload module) installed on the proxy server and are compared with the information which is supplied by the data mining program to the proxy server. Working from the priority criteria and the information provided by the data mining program, the preload module selects the appropriate web pages which are to be preloaded, i.e. downloaded in anticipation. This is done as shown in FIG. 2.

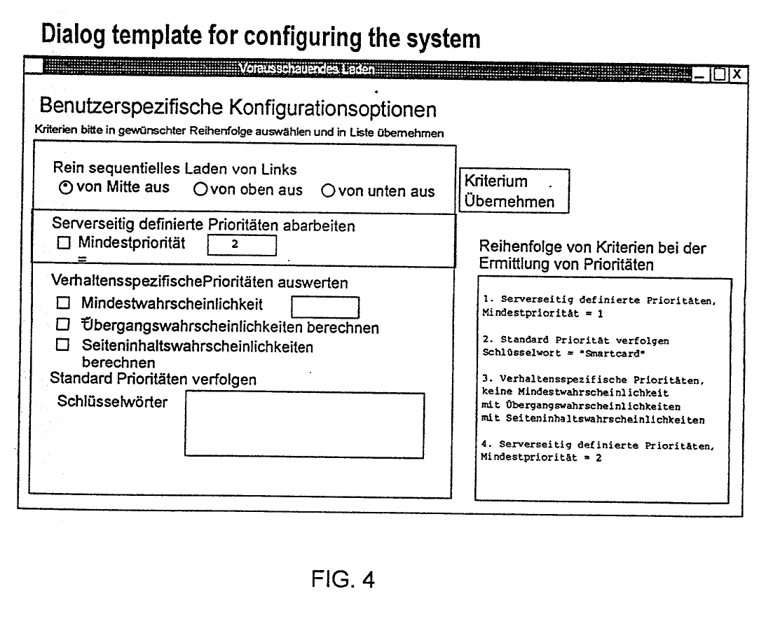

FIG. 4 shows an example of a dialogue template for configuring the implementations shown in FIGS. 2 and 3.

The user can preferably fill in the dialog template in the preset sequence.

Where the user has selected sequential downloading, the downloading takes place without any selection of the content which is downloaded. However, the sequential downloading can be acted on by means of the parameters, “from the centre”, “top-down” and “bottom-up”.

Where the links to the web pages already contain priority information, the user can assign a lowest priority. In the example shown, this is a priority of 2. All links down to a priority of 2 are downloaded in anticipation.

Finally, the user can select behaviour-specific priorities. As part of this he can set a lowest probability. If the links identified do not meet this lowest probability requirement, they are ignored. The possibility also exists of selecting “changeover probabilities” and “page-content probabilities”. As well as this, the user can select “standard priorities” by entering a code word.

The priorities selected can be re-arranged into a sequence relative to one another. On the right of the dialog template shown as an example, the selection options are prioritised as follows:

Priority 1 has the priority defined at the server end. On the web page being viewed, all those subsequent links will be downloaded in anticipation which have already been given an HTML tag of “Prio=1” at the server end. With this configuration, “Prio=2” would be ignored.

Priority 2 have all the subsequent links which have the code word “Smartcard”.

Under priority 3, the data miner determines which subsequent links are most probable. No lowest probability has been selected.

Changeover probabilities are cases where, for example, when somebody is on a corporate web site, he will often want to change over to look at the share prices quoted for the company as well.

Page-content probabilities cause the data miner to take account of whether the description included in the link mentions current favourite subjects.

Priority 4 is like priority 1 except that links marked Prio=2 are also included.

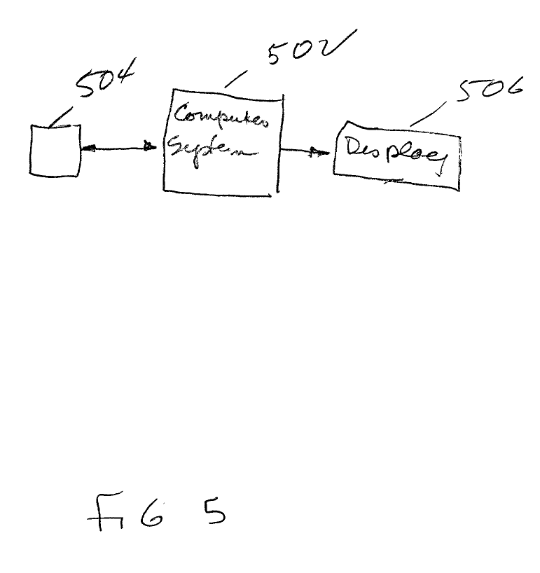

As shown in FIG. 5, the software for performing the functions of the present invention can be provided, or the results received, from a computer system 502 and placed on a computer useable media 504, such as an optical or magnetic media, and can be displayed on a computer responsive display system 506.

It should be apparent that a number of changes, substitutions and alterations can be made to what has been described. Therefore, it should be understood that the present invention is not limited to what has been described but includes those embodiments within the scope and spirit of the appended claims.

What is claimed is:

1. A method of downloading information from the network to a client where the client is connected to the network by a data line, comprising the following steps:
a) downloading of information from the network to the client
b) displaying of the information on the client's machine by a browse
c) automatically checking of the information displayed for the presence of links to other sets of information at a point no later than the display of the information in step b)
d) automatically assigning of priorities to the links identified
e) automatically downloading to the client's machine of the sets of information assigned to the links in accordance with the priorities of the sets of information.

2. The method according to claim 1, including the following further steps:
a) selecting and displaying on the client's machine a set of information from step e)
b) repeating steps c) to e) of the method for this set of information.

3. The method according to claim 1, including the steps of expanding the links to include priority information and the downloading the sets of information assigned to the links concerned in the sequence set by the priorities.

4. The method according to claim 3, wherein the assigning of a priority by expanding the links to include priority information is performed by the author of the set of information concerned.

5. The method according to claim 1, including the step of assigning priority to the links in a purely sequential order.

6. The method according to claim 5, including the step of sequentially assigning of the priorities to the links by at least one of the options “from centre”, “top-down” and “bottom-up”.

7. The method according to claim 1, including the steps of performing the assignment of priorities to the links by analysing user behaviour by means of a data mining program, storing all the sets of information downloaded from the network, or parts thereof, on the client's machine, using a data mining program for accessing this information and analysing it statistically, and creating a sequence of priorities for the links by using an add-on program or browse extension.

8. The method according to claim 1, including the step of allowing the user to set priority options by means of a user profile.

9. The method according to claim 8, including the step of providing the user with one or more of the following user-specifiable options:
purely sequential downloading of links from centre/top-down/bottom-up;
downloading of sets of information whose links include priorities down to a lowest priority which can be decided by the user;
following of a standard priority as a result of the entry of a code word;
assigning priorities as a result of analysis of user behaviour, set by means of the following options:
specification of a lowest probability to be specified by user;
calculation of changeover probability;
calculation of site-content probability.

10. The method according to claim 9, including the step of selecting between allowing the user profile to automatically assigns a priority to the options selected or permitting the assignment of the priority to be performed by the user.

11. The method according to claim 1, wherein the information which is loaded in anticipation is stored in the client's RAM cache or hard-disk cache.

12. The method according to claim 1, wherein steps c) to e) are performed by an add-on program or browse extension, the add-on program being installed on the client and communicating with the browse via an interface.

13. The method according to claim 10, wherein the user profile is part of the browse extension or add-on program.

14. The method of downloading information from a network to a client where communications between the client and the network are handled via a server which has a data line to the client and to the network, comprising the following steps:
a) downloading of information from the network to the server and displaying of the information on the client's machine by a browse
b) automatically checking the information represented in the server for the presence of links to other information at a point no later than the completion of the display of the information on the client's machine in step a)
c) automatically assigning in the server of priorities to the links identified
d) automatically downloading to the server of the sets of information assigned to the links in accordance with the priorities of the links.

15. The method according to claim 14, including the following further steps:
f) selecting and displaying on the client's machine of information which was downloaded in anticipation in step d) and
g) automatically repeating of steps b) to d) of the method for this information.

16. The method according to claim 14, including the step of expanding the links to include priority information and downloading the sets of information assigned to the links concerned in the sequence set by the priorities.

17. The method according to claim 14, wherein the assignment of a priority by expanding the links to include priority information is performed by the author of the set of information concerned.

18. The method according to claim 14, including the step of assigning priority to the links found in a purely sequential order.

19. The method according to claim 18, including the step of sequentially assigning of the priorities to the links by at least one of the options “from centre”, “top-down” and “bottom-up”.

20. The method according to claim 14, including the steps of performing the assignment of priorities to the links found is performed by analysing user behaviour by means of a data mining program, storing all the information downloaded from the network, or parts thereof, on the client's machine using a data mining program accessing this information and creating a sequence of priorities for the links found.

21. The method according to claim 14, including the step of allowing the operator of the server to set priority options by means of a user profile.

22. The method according to claim 21, including the step of providing the user with one or more of the following user-specifiable options:
purely sequential downloading of links from centre/top-down/bottom-up;
downloading of sets of information whose links include priorities down to a lowest priority which can be decided by the user;
following of a standard priority as a result of the entry of a code word;
assigning of priorities as a result of analysis of user behaviour, set by means of the following options:
specification of a lowest probability to be specified by user;
calculation of changeover probability;
calculation of site-content probability.

23. The method according to claim 22, including the step of selecting between allowing the user profile to automatically assign a priority to the options or permitting the priority to be performed by the user.

24. A computer program on a computer useable medium for downloading information from the network to a client where the client is connected to the network by a data line, comprising:
a) software for downloading of information from the network to the client
b) software for displaying of the information on the client's machine by a browse
c) software for automatically checking of the information displayed for the presence of links to other sets of information at a point no later than the display of the information in step b)
d) software for automatically assigning of priorities to the links identified
e) software for automatically downloading to the client's machine of the sets of information assigned to the links in accordance with the priorities of the sets of information.

25. The computer program according to claim 24, including:
a) software for selecting and displaying on the client's machine a set of information from step e)
b) software for repeating steps c) to e) of the method for this set of information.

26. The computer program according to claim 24, including software expanding the links to include priority information and the downloading the sets of information assigned to the links concerned in the sequence set by the priorities.

27. The computer program according to claim 24, including software for assigning priority to the links in a purely sequential order.

28. The computer program according to claim 27, including software for sequentially assigning of the priorities to the links by at least one of the options “from centre”, “top-down” and “bottom-up”.

29. The computer program according to claim 24, including software for performing the assignment of priorities to the links by analysing user behaviour by means of a data mining program, storing all the sets of information downloaded from the network, or parts thereof, on the client's machine, using a data mining program for accessing this information and analysing it statistically, and creating a sequence of priorities for the links by using an add-on program or browse extension.

30. The according to claim 1, including the step of allowing the user to set priority options by means of a user profile.

31. The computer program according to claim 30, including software for providing the user with one or more of the following user-specifiable options:
purely sequential downloading of links from centre/top-down/bottom-up;
downloading of sets of information whose links include priorities down to a lowest priority which can be decided by the user;
following of a standard priority as a result of the entry of a code word;
assigning priorities as a result of analysis of user behaviour, set by means of the following options:
specification of a lowest probability to be specified by user;
calculation of changeover probability;
calculation of site-content probability.

32. The software according to claim 31, including software for selecting between allowing the user profile to automatically assigns a priority to the options selected or permitting the assignment of the priority to be performed by the user.
